(19) United States
(12) Patent Application Publication
(10) Pub. No.: US 2012/0234419 A1
(43) Pub. Date: Sep. 20, 2012

(54) WATER CHANNEL SWITCHING STRUCTURE FOR A FAUCET

(75) Inventor: SHUN-FA HSIEH, Changhua (TW)

(73) Assignee: MING YU INDUSTRIAL CO. LTD, Rosemead, CA (US)

(21) Appl. No.: 13/050,004

(22) Filed: Mar. 17, 2011

(51) Int. Cl. F16K 31/44

(52) U.S. Cl. 137/801

(57) ABSTRACT

A water channel switching structure in a faucet includes a faucet body and a switching unit, wherein the faucet body has the switching unit near a gate, and the switching unit has one control stick, a connecting unit, a driving stick and a valve piece. A connecting end of the control stick is connected with the connecting unit and one side of the connecting unity has a supporting surface to be against a resilient unit. The other side of the connecting unit has a through connecting hole that can be passed through by the driving stick with a connecting end. One side of the valve piece is an attaching surface that is attached to the gate of the faucet body, and an interconnecting hole is recessedly formed to connect with the connecting end of the driving stick. According to the structure stated above, when the water is cut off, the connecting unit is pushed by the resilient unit to force the valve piece to detach from the gate, which can actually achieve the goal of automatic switching.

### FIELD OF THE INVENTION

The present invention is related to a structure for switching water channel in a faucet, and more specifically when the water from a water source is cut off, a connecting unit is pushed by a resilient unit to force a valve piece to detach from a gate to achieve the goal of automatic switching.

### BACKGROUND OF THE INVENTION

A conventional faucet structure is shown in FIG. 7, including: an outlet head (30) and a switching component (40), wherein the outlet head (30) is tubular and forms a water inlet (31) and a water outlet (32) on both sides of the outlet head (30); the water inlet (31) having a water inlet cap (311) which has a water control hole (312), and the water inlet (31) and the water outlet (32) inwardly shrinking to form a water gate (33) therebetween, which has the switching component (40) which has a valve (41), a driving rod (42), a connecting piece (43) and a control rod (44), wherein the valve (41) is attached to one side of the water gate (33) and more specifically attached to a sealing rubber (411), one end of the driving rod (42) passes through the connecting piece (43) and engages with the valve (41), and the other end of the driving rod (42) is connected with a restricting position unit (421). An upper portion of the connecting piece (43) is connected with the control rod (44) that passes through the outlet head (30). When using the faucet, water is provided at the water inlet (31) of the outlet head (30) and when a user pulls the control rod (44), the valve seals the water gate (33) and the water can be directed out from a shower head. When there is no water source, the water pressure in the outlet head (30) decreases, and when the water pressure is lower than the weight of the valve (41), the valve (41) detaches from the water gate (33) to achieve the goal of automatically switching the water outlet position of the outlet head (30), and to avoid a situation that when using the shower head next time, the water may be out from the shower head unexpectedly. However, the disadvantage of the conventional faucet is that when there is no water source, the valve (41) may not be automatically switched due to high residual water pressure, which may cause some inconvenience to the user.

Therefore, there remains a need for a new and improved water channel switching structure in the faucet to overcome the abovementioned issues to effectively switch water channel in the faucet when the water from the water source is cut off.

### SUMMARY OF THE INVENTION

The technical problem to be solved in the present invention: when there is no water source, the valve may not be automatically switched due to high residual water pressure, which may cause some inconvenience to the user, and this is the technical problem the present invention wants to solve.

The technical point to solve the problem mentioned above: the present invention provides a water channel switching structure in a faucet, including a faucet body, which is tubular and forms an inlet end and an outlet end on both sides of the body, and the inlet end and the outlet shrink inwardly to form a gate therebetween; and the faucet body having a through hole near the gate; and a switching unit having a control stick, a connecting unit, a driving stick and a valve piece, wherein the control stick has a pulling end and a through end, which is adapted to pass through the through hole of the faucet body and connected with the connecting unit, wherein a supporting surface is formed at one side of the connecting unit and one end of a resilient unit is against the supporting surface, and the other side of the connecting unit has a through connecting hole which is provided for the driving stick to pass through and one end of the driving stick has a conjugating end, wherein the valve piece has an attaching surface on one side that is attached to the gate of the faucet body, and an interconnecting hole is recessedly formed on the attaching surface to engage an interconnecting end of the driving stick to form a water channel switching structure in the faucet.

Comparing with conventional techniques, the present invention provides a water channel switching structure in the faucet. When the water is cut off, the inlet water pressure from the water source decreases and there is some residual pressure in the faucet body. Meanwhile, the connecting unit is pushed by the resilient unit to force the valve piece to detach from the gate to actually achieve the goal of automatic switching.

### BRIEF DESCRIPTION OF THE DRAWINGS

FIG. 1 illustrates a three-dimensional assembled view in the present invention.

FIG. 2 illustrates a three-dimensional exploded view in the present invention.

FIG. 3 illustrates a sectional schematic view in the present invention.

FIG. 4 illustrates schematic view of a valve piece blocking a gate in the present invention.

FIG. 5 is a schematic view of automatic switching in the present invention.

FIG. 6 is a schematic view of the valve piece detaching from the gate in the present invention.

FIG. 7 is a sectional schematic view of conventional techniques.

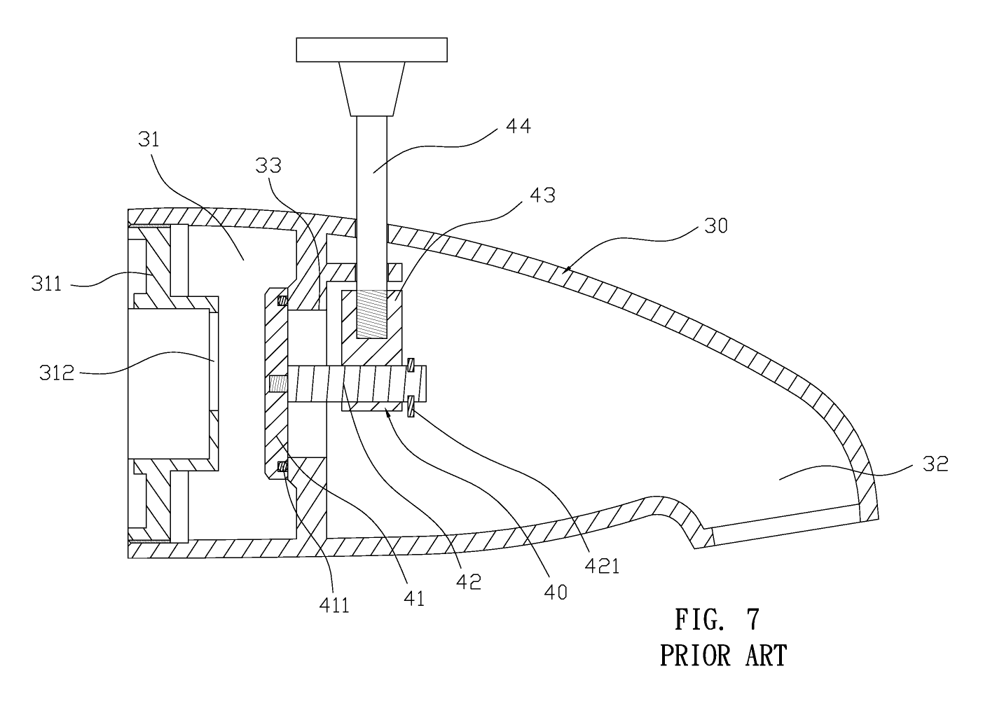

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

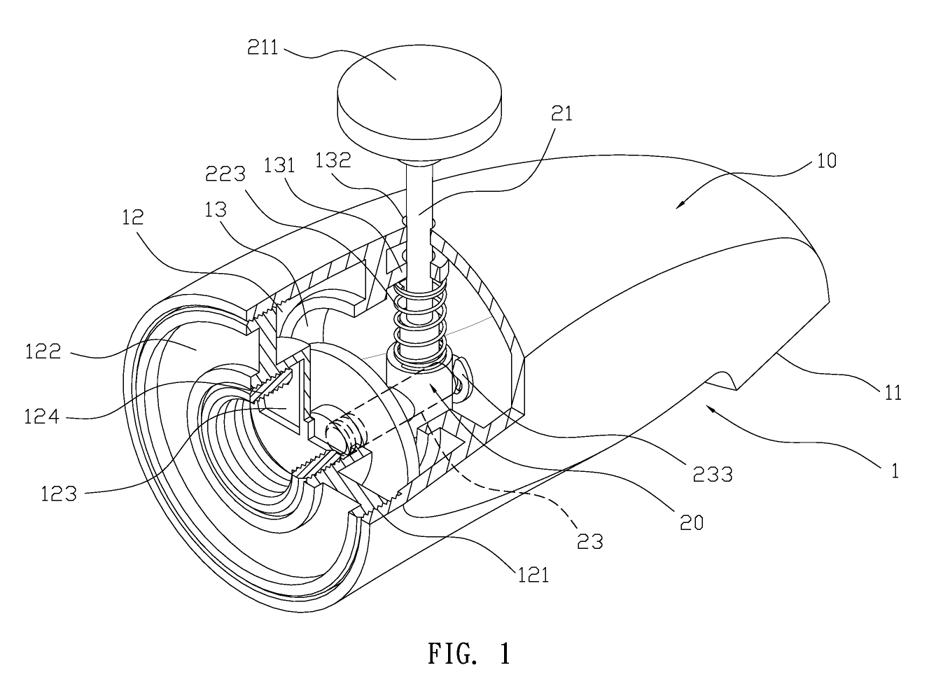

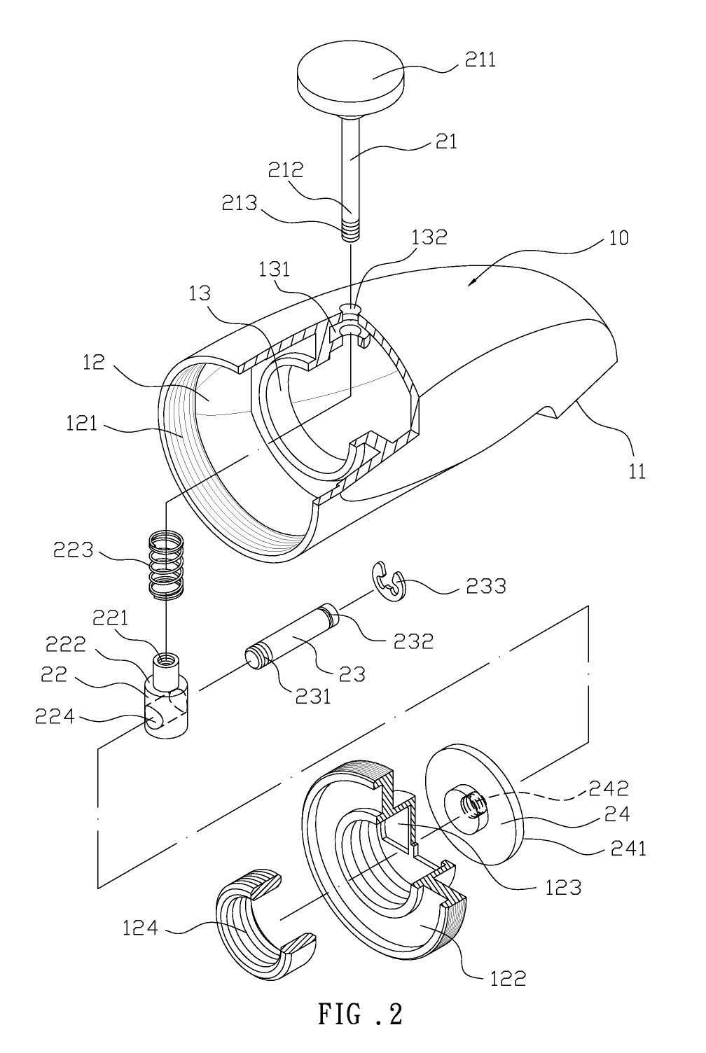

Referring to FIGS. 1 to 2, a water channel switching structure of a faucet (1) including: a faucet body (10) and switching unit (20), wherein the faucet body is tubular and forms an inlet end (11) and an outlet end (12) on both sides of the body; the inlet end (11) having an inner thread to engage with an inlet cap (122) which has an inlet hole (123) through one side to engage with a connecting tube (124), and the inlet end (11) and the outlet (12) inwardly shrinking to form a gate (13) therebetween, wherein the faucet body (10) forms a protruding blocking unit (131) near the gate (13), which passes through a through hole (132). The switching unit (20) has a control stick (21), a connecting unit (22), a driving stick (23) and a valve piece (24), wherein the control stick (21) has a pulling end (211) and a through end (212), which has a engaging mark (213) and is adapted to pass through the through hole (132) of the faucet body (10). The connecting unit (22) has a conjugating hole (221) recessedly located at one side of the connecting unit (22) and the conjugating hole (221) is engaged with the engaging mark (213) of the control stick (21). A supporting surface (222) is near the conjugating hole (221), and one end of a resilient unit (223) is against the supporting surface (222) while the other end is against the blocking unit (131). The other side of the connecting unit (22) has a through connecting hole (224) which is provided for the driving stick (23) to pass through, and a restricting slot (232) is formed tangentially at the other end and provides a restricting unit (233) which is a C-shaped buckle to conjugate therewith. The valve piece (24) has an attaching surface (241) on one side that can be attached with the gate (13) of the faucet body (10), and an interconnecting hole (242) is recessedly formed on the attaching surface (241) to engage an interconnecting end (231) of the driving stick (23).

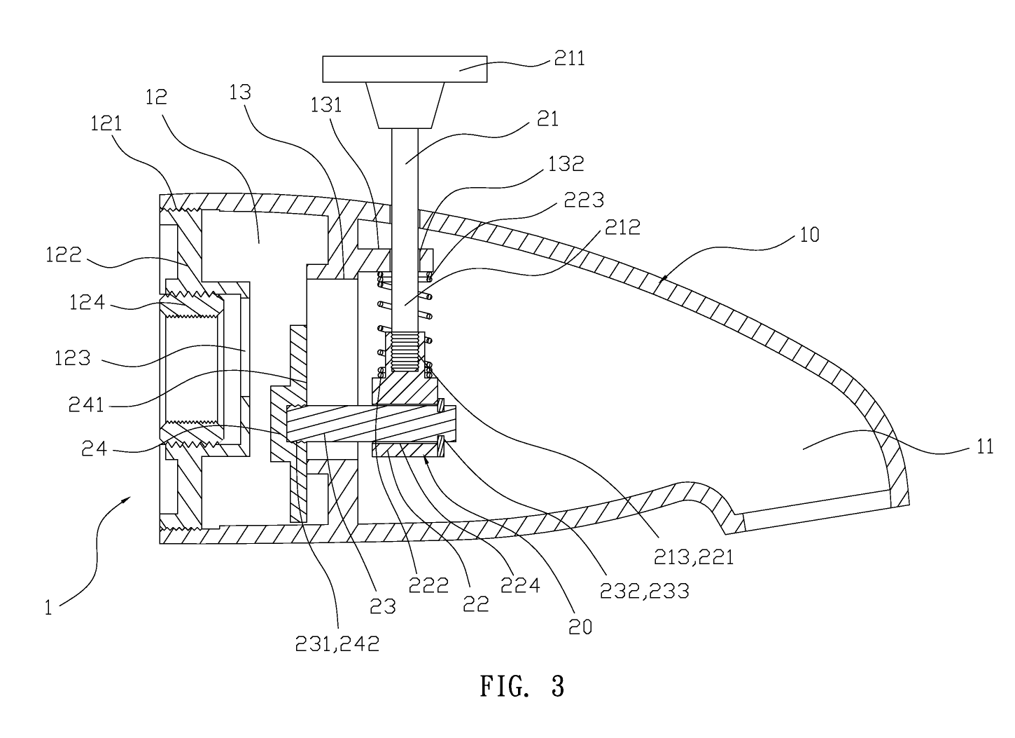

Still referring to FIG. 2 along with FIG. 3 for the assembled structure in the present invention, the through end (212) of the control stick (21) passes through the through hole (132) of the faucet body (10), the conjugating hole (221) of the connecting unit (22) is engaged with the engaging mark (213) of the control stick (21), the interconnecting end (231) of the driving stick (23) passes through the connecting hole (224) of the connecting unit (22), and the control stick (21) is rotated so that the interconnecting end (231) of the connecting unit (22) is at the gate (13) to engage the interconnecting hole (242) of the valve piece (24) with the interconnecting end (231) to complete the assembly.

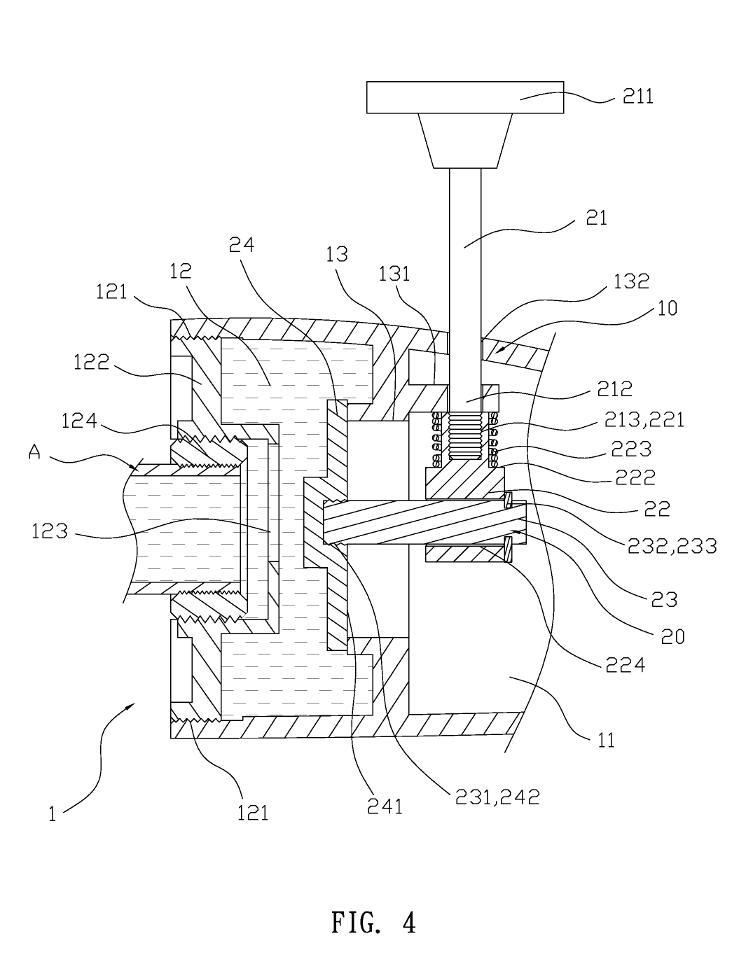

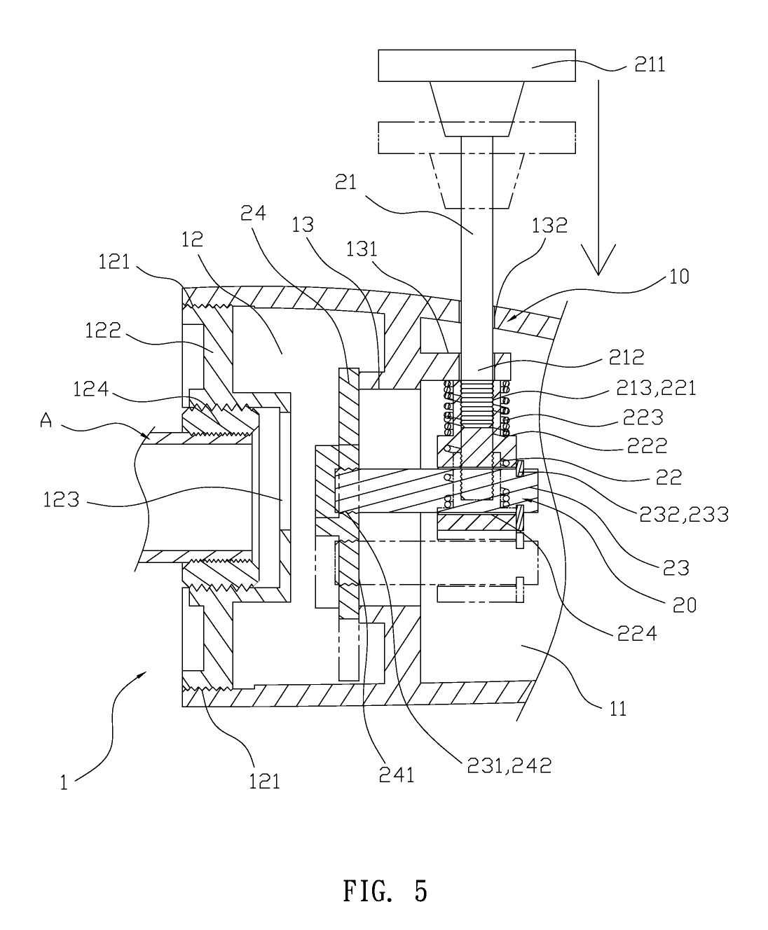

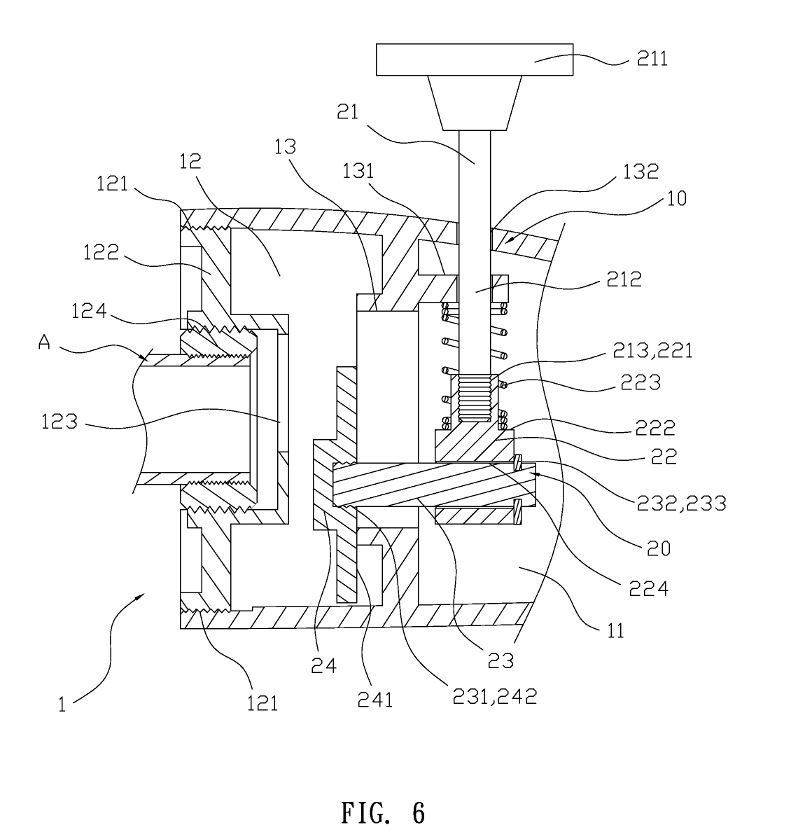

Still referring to FIG. 3 along with FIG. 4 for actually practicing the present invention, a water source (A) is connected with the connecting tube (124) of the inlet cap (122) of the faucet body (10) and the water source (A) can also be connected upwards to a shower head (not shown). When the faucet (1) is not actuated, the valve piece (24) of the switching unit (20) detaches from the gate (13) of faucet body (10) due to its gravity. When the water source (A) provides water, the water flows from the inlet hole (123) to the inlet end (12), gate (13) and outlet end (11) orderly, and when a user wants to use the shower head, the user can operate the pulling end (211) of the control stick (21) of the switching unit (20), so that the valve piece (24) can be actuated by the connecting stick (23) through the control stick (21). Also, the resilient unit (223) is compressed to force the valve piece (24) to block the gate (13), and more specifically the valve piece (24) is under water pressure from the water source (A) to closely attach to and further seal the gate (13) (see FIG. 4), so the water can be directed out from the shower head. Referring to FIG. 5, when the water from the water source (A) is cut off, the inlet water pressure from the water source (A) decreases and the inlet end (12) of the faucet (10) has some residual pressure, so the connecting unit (22) is pushed by the resilient unit (223) and further drive the valve piece (24) to detach from the gate (13) (see FIG. 6) to achieve the goal of automatic switching.

The advantage of the present invention according to the embodiments stated above is: when the water from the water source (A) is cut off, the inlet water pressure from the water source (A) decreases and the inlet end (12) of the faucet (10) has some residual pressure, so the connecting unit (22) is pushed by the resilient unit (223) and further drive the valve piece (24) to detach from the gate (13) to achieve the goal of automatic switching.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water channel switching structure in a faucet, comprising:
a faucet body, which is tubular and forms an inlet end and an outlet end on both sides of the body, and the inlet end and the outlet shrink inwardly to form a gate therebetween; and the faucet body having a through hole near the gate; and
a switching unit having a control stick, a connecting unit, a driving stick and a valve piece, wherein the control stick has a pulling end and a through end, which is adapted to pass through the through hole of the faucet body and connected with the connecting unit, wherein a supporting surface is formed at one side of the connecting unit and one end of a resilient unit is against the supporting surface, and the other side of the connecting unit has a through connecting hole which is provided for the driving stick to pass through and one end of the driving stick has a conjugating end, wherein the valve piece has an attaching surface on one side that is attached to the gate of the faucet body, and an interconnecting hole is recessedly formed on the attaching surface to engage an interconnecting end of the driving stick.

2. The water channel switching structure of claim 1, wherein the inlet end has an inner thread to engage with an inlet cap that has an inlet hole through one side to engage with a connecting tube.

3. The water channel switching structure of claim 1, wherein a blocking unit is formed protrudingly near the gate of the faucet body and the blocking unit is against the other end of the resilient unit.

4. The water channel switching structure of claim 1, wherein a restricting slot is formed tangentially at the other end of the driving stick and the restricting slot provides a restricting unit to conjugate therewith.

5. The water channel switching structure of claim 4, wherein a receiving unit is a C-shaped buckle.
